(19) United States
(12) Patent Application Publication
(10) Pub. No.: US 2023/0018426 A1
(43) Pub. Date: Jan. 19, 2023

(54) PUNCHING PIECE OF PERMANENT MAGNET MOTOR ROTOR FOR VEHICLE AND ROTOR SKEWING STRUCTURE THEREOF

(71) Applicant: HEFEI JEE POWER SYSTEMS CO., LTD., Hefei (CN)

(72) Inventors: Qixiang SHEN, Hefei (CN); Zaihao CHEN, Hefei (CN)

(73) Assignee: HEFEI JEE POWER SYSTEMS CO., LTD., Hefei (CN)

(21) Appl. No.: 17/710,436

(22) Filed: Mar. 31, 2022

Related U.S. Application Data
(63) Continuation of application No. PCT/CN2021/132292, filed on Nov. 23, 2021.

(30) Foreign Application Priority Data
Jul. 13, 2021 (CN) 202110800057.X

(51) Int. Cl. H02K 15/03; H02K 1/28

(52) U.S. Cl. CPC H02K 15/03; H02K 1/28

(57) ABSTRACT

Disclosed are a punching piece of a permanent magnet motor rotor for a vehicle and a rotor skewing structure thereof. The punching piece of the rotor includes an inner punching piece and an outer punching piece, a center of the inner punching piece is provided with a mounting hole for fixedly installing a rotating shaft, a side wall of the mounting hole is provided with a plurality of rotating shaft matching keyways evenly distributed in a circumferential direction, and the rotating shaft is provided with at least one rotating shaft matching key extending along an axial direction of the rotating shaft, the at least one rotating shaft matching key is in interference fit with the rotating shaft matching keyway, a plurality of matching keys are provided at an outer wall of the inner punching piece, inner wall matching keyways are provided at an inner wall of the outer punching piece correspondingly.

### CROSS-REFERENCE TO RELATED APPLICATIONS

This application is a continuation of International Application PCT/CN2021/132292, filed on Nov. 23, 2021, which claims priority to Chinese Patent Application No. 202110800057.X, filed on Jul. 13, 2021, the entire contents of which are incorporated herein by reference.

### TECHNICAL FIELD

The present application belongs to the technical field of motor, in particular to a punching piece of a permanent magnet motor rotor for a vehicle and a rotor skewing structure thereof.

### BACKGROUND

Permanent magnet synchronous motor is a synchronous motor excited by permanent magnet to produce synchronous rotating magnetic field. Compared with AC asynchronous motor, permanent magnet synchronous motor has higher efficiency and smaller volume, and can give better play to advantages of energy conservation and emission reduction of new energy vehicles. Therefore, permanent magnet synchronous motor is often used in new energy vehicles. At present, the punching piece of permanent magnet synchronous motor for vehicle is generally designed as a whole. The rotor skewing structure of the rotor is generally realized by using a variety of punching pieces of rotors, and the same rotor skewing structure is relatively single, and the rotor skewing structure is unchanged, which is generally shaped like a straight line or a “V”.

### SUMMARY

In view of the above existing technical problems, the present application provides a punching piece of a permanent magnet motor rotor for a vehicle and a rotor skewing structure thereof.

The technical scheme of the present application is:

A punching piece of a permanent magnet motor rotor for a vehicle, comprising an inner punching piece and an outer punching piece, a center of the inner punching piece being provided with a mounting hole for fixedly installing a rotating shaft, a side wall of the mounting hole being provided with a plurality of rotating shaft matching keyways evenly distributed in a circumferential direction, and the rotating shaft being provided with at least one rotating shaft matching key extending along an axial direction of the rotating shaft, the at least one rotating shaft matching key being in interference fit with the rotating shaft matching keyway, a plurality of matching keys being provided at an outer wall of the inner punching piece, inner wall matching keyways being provided at an inner wall of the outer punching piece correspondingly, and the inner punching piece being fixedly connected with the outer punching piece through interference fit between the matching keys and the inner wall matching keyways; the outer punching piece being provided with a plurality of first magnetic steel slots arranged along a circle and distributed close to an inner side of the outer punching piece and a plurality of second magnetic steel slots arranged along a circle and distributed away from the inner side of the outer punching piece, the outer wall of the outer punching piece being provided with a straight axis groove in the straight axis direction, and the outer wall of punching piece being provided with a cross axis groove in the cross axis direction.

In one embodiment, a number of straight shaft grooves is equal to a number of motor poles, a number of cross shaft grooves is equal to a number of motor poles, and the straight shaft grooves and the cross shaft grooves are arranged alternately.

In one embodiment, two first magnetic steel slots form a pair and constitute a “V” shape, and each pair of first magnetic steel slots are symmetrically distributed along a radial direction of the outer punching piece.

In one embodiment, two second magnetic steel slots 23 form a pair and constitute a straight line shape, and each pair of second magnetic steel slots are symmetrically distributed along the radial direction of the outer punching piece.

In one embodiment, a gap between bottoms of the pair of first magnetic steel slots forms a first magnetic isolation bridge, a width of the first magnetic isolation bridge is not less than 1 mm and not greater than 2 mm, a gap between the pair of second magnetic steel slots forms a second magnetic isolation bridge, and a width of the second magnetic isolation bridge is not less than 0.7 mm and not greater than 1.2 mm.

In one embodiment, a straight shaft groove is a circular arc groove, and a radius of the straight shaft groove is not less than 1.1 times and not greater than 1.5 times the width of the first magnetic isolation bridge.

In one embodiment, the cross axis groove is a circular arc groove, and a radius of the cross axis groove is not less than 1.1 times and not greater than 1.5 times the width of the second magnetic isolation bridge.

In one embodiment, the outer punching piece is made of silicon steel and the inner punching piece is made of aluminum.

A rotor skewing structure of a permanent magnet motor for a vehicle, a punching piece of a permanent magnet motor rotor for a vehicle as mentioned above is adopted, comprising a rotating shaft and a plurality of punching pieces of a permanent magnet motor rotor sleeved on the rotating shaft through the mounting hole, a rotating shaft matching key is interference fit with the rotating shaft matching keyway at a plurality of different angles on the inner punching piece to realize the multi-segment rotor skewing of the rotor with a V shape, a straight line shape, or a zigzag shape.

In one embodiment, the number of matching keyways of the rotating shaft is greater than or equal to the number of segments of multi-segment rotor skewings of the rotor.

The beneficial effects of the present application are:

The punching piece of the rotor of the present application adopts an inner punching piece and an outer punching piece, and an outer wall of the outer punching piece is provided with a straight axis groove and an across axis groove, which is helpful to reduce the torque ripple of the motor and reduce the electromagnetic force of the motor. The second magnetic steel groove in the present application is distributed in pairs in a straight line shape. These two segments of “one shaped” structure are different from the existing integral one shaped structure, which can effectively reduce the generation of magnetic field leakage flux, improve the material utilization rate of permanent magnet and reduce the cost. In the present application, the outer punching piece adopts silicon steel material with high permeability, and the inner punching piece adopts high hardness aluminum material with low permeability. The outer punching piece helps to ensure that the main magnetic flux of a magnetic field of the permanent magnet will not be weakened and ensure the output performance of the motor. The density of the aluminum material adopted by the inner punching piece is low, which greatly reduces the overall weight of the rotor and ensures the strength of the rotor. It also reduces the flux leakage of the magnetic field of the permanent magnet and improves the power density of the motor. The present application can realize the rotor skewing structure with different rotor skewing angles through the interference fit between the rotating shaft matching key and a plurality of rotating shaft matching keyways with different angles on the inner punching piece, such as the multi-segment rotor skewing of the rotor with a V shape, a straight line shape, or a zigzag shape.

### BRIEF DESCRIPTION OF THE DRAWINGS

The present application is further described below in combination with the accompanying drawings and the embodiments.

FIG. 1 is a schematic structural view of a punching piece of a rotor of the present application.

FIG. 2 is a schematic structural view of an outer punching piece of the present application.

FIG. 3 is a structural view of an inner punching piece of the present application.

FIG. 4 is a structural view of a rotating shaft of the present application.

FIG. 5 is an assembly view of a single punching piece and the rotating shaft of the present application.

FIG. 6 is a schematic structural view of a rotor skewing of the present application.

### DETAILED DESCRIPTION OF THE EMBODIMENTS

In order to make the purpose, technical scheme and advantages of the present application more clear, the present application is further described in detail in combination with the specific embodiments and with reference to the accompanying drawings. It should be understood that these descriptions are exemplary only and are not intended to limit the scope of the present application. In addition, in the following description, the description of the well-known structure and technology is omitted to avoid unnecessary confusion of the concept of the present application.

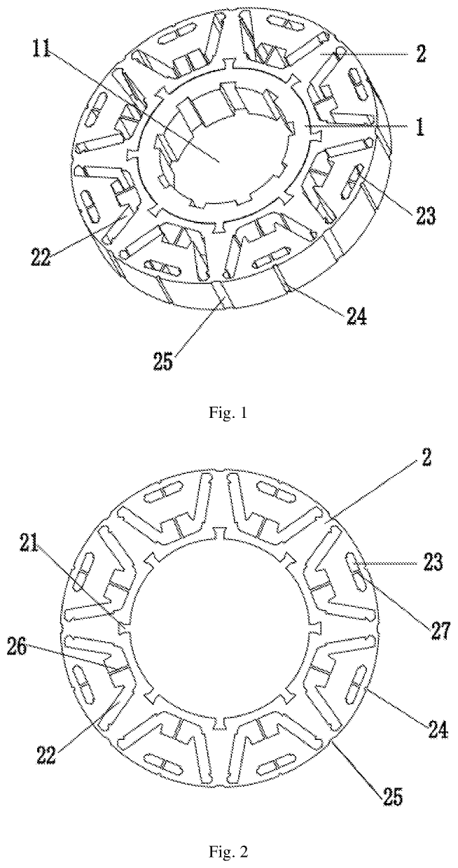

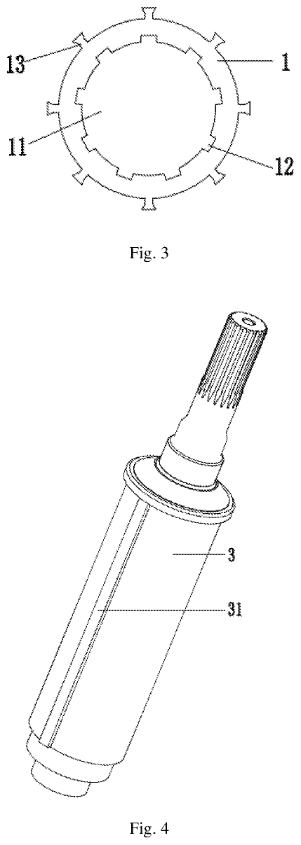

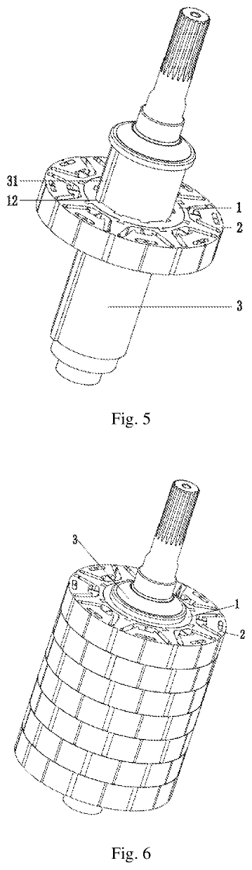

As shown in FIGS. 1 to 5, a punching piece of a permanent magnet motor rotor for a vehicle includes an inner punching piece 1 and an outer punching piece 2. A center of the inner punching piece 1 is provided with a mounting hole 11 for fixedly installing the rotating shaft 3, a side wall of the mounting hole 11 is provided with a plurality of rotating shaft matching keyways 12 evenly distributed in the circumferential direction, and a rotating shaft 3 is provided with at least one rotating shaft matching key 31 extending along the axial direction of the rotating shaft 3. The rotating shaft matching key 31 is in interference fit with the rotating shaft matching keyway 12. A plurality of matching keys 13 are arranged at an outer wall of the inner punching piece 1, and inner wall matching keyways are provided at an inner wall of the outer punching piece 2 correspondingly. The inner punching piece 1 and the outer punching piece 2 are fixedly connected through the interference fit of the matching keys 13 with the inner wall matching keyways.

The outer punching piece 2 is provided with a plurality of first magnetic steel slots 22 arranged along a circle and distributed close to an inner side of the outer punching piece 2 and a plurality of second magnetic steel slots 23 arranged along a circle and distributed away from the inner side of the outer punching piece 2. The number of the second magnetic steel slots 23 is equal to the number of the first magnetic steel slots 22. Two first magnetic steel slots 22 form a pair and constitute a “V” shape, two second magnetic steel slots 23 form a pair and constitute a straight line shape, and each pair of first magnetic steel slots 22 are symmetrically distributed along a radial direction of the outer punching piece 2. A gap between bottoms of the pair of first magnetic steel slots 22 forms a first magnetic isolation bridge 26, a width of the first magnetic isolation bridge 26 is not less than 1 mm and not greater than 2 mm. Each pair of second magnetic steel slots 23 are symmetrically distributed along the radial direction of the outer punching piece 2, a gap between the pair of second magnetic steel slots 23 forms a second magnetic isolation bridge 27, and a width of the second magnetic isolation bridge 27 is not less than 0.7 mm and not greater than 1.2 mm. This Two segment structure is different from the existing one segment structure, and can effectively reduce the generation of the leakage flux of magnetic field, and improve the material utilization of permanent magnet and reduce the cost. In addition, the outer wall of the outer punching piece 2 is provided with straight shaft grooves 24 in the straight axis direction, and the outer wall of the outer punching piece 2 is provided with cross shaft grooves 25 in the cross axis direction. The number of straight shaft grooves 24 is equal to the number of motor poles, and the number of cross shaft grooves 25 is also equal to the number of motor poles. The straight shaft grooves 24 and the cross shaft grooves 25 are arranged alternately, and the straight shaft grooves 24 and the cross shaft grooves 25 are circular arc grooves. The radius of the straight shaft groove 24 is not less than 1.1 times and not greater than 1.5 times the width of the first magnetic isolation bridge 26, and the radius of the cross shaft groove 25 is not less than 1.1 times and not greater than 1.5 times the width of the second magnetic isolation bridge 27. The setting of the straight shaft grooves 24 and the cross shaft grooves 25 helps to reduce the motor torque ripple and reduce the motor electromagnetic force.

The outer punching piece 2 is made of silicon steel with high permeability, and the inner punching piece 1 is made of high hardness aluminum material with low permeability. The outer punching piece 2 helps to ensure that the main magnetic flux of the magnetic field of the permanent magnet will not weaken and ensure the output performance of the motor. The aluminum material used in the inner punching piece 1 has a low density, which greatly reduces the overall weight of the rotor and ensures the strength of the rotor. It also reduces the flux leakage of the magnetic field of the permanent magnet and improves the power density of the motor.

As shown in FIG. 6, a rotor skewing structure of the permanent magnet motor for a vehicle adopts the above punching piece of the permanent magnet motor rotor for a vehicle, including a rotating shaft 3 and seven permanent magnet motor rotor punching pieces sleeved on the rotating shaft 3 through the mounting holes 11. The number of rotating shaft matching keyways 12 is greater than or equal to the number of segments of multi-segment rotor skewings of the rotor. The inclined angle between the radial symmetry lines of two adjacent rotating shaft matching keyways 12 is determined by an angle of the segment of the rotor skewing of the rotor, which can be understood that a punch piece can realize a variety of skewing angles, and the implementation method is determined by the angle between the adjacent inner ring keyways 12 of the inner punch pieces 1. For example, the angle between the adjacent two keyways is 2 degrees, that is, the skewing angle is 2 degrees. The rotating shaft matching keys 31 are interference fit with a plurality of rotating shaft matching keyways 12 at different angles on the inner punching piece 1 to realize the rotor skewing structure with different angles of the rotor skewing, such as the multi-segment rotor skewing with a V shape, a straight line shape, or a zigzag shape.

It should be understood that the above specific embodiments of the present application are only used to illustrate or explain the principles of the present application by way of example, and do not constitute a limitation of the present application. Therefore, any modification, equivalent replacement, improvement, etc. made without departing from the spirit and scope of the present application should be included in the protection scope of the present application. In addition, the appended claims of the present application are intended to cover all changes and modifications falling within the scope and boundary of the appended claims or equivalent forms of such scope and boundary.

1. A punching piece of a permanent magnet motor rotor for a vehicle, comprising an inner punching piece and an outer punching piece, a center of the inner punching piece being provided with a mounting hole for fixedly installing a rotating shaft, a side wall of the mounting hole being provided with a plurality of rotating shaft matching keyways evenly distributed in a circumferential direction, and the rotating shaft being provided with at least one rotating shaft matching key extending along an axial direction of the rotating shaft, the at least one rotating shaft matching key being in interference fit with the rotating shaft matching keyway, a plurality of matching keys being provided at an outer wall of the inner punching piece, inner wall matching keyways being provided at an inner wall of the outer punching piece correspondingly, and the inner punching piece being fixedly connected with the outer punching piece through interference fit between the matching keys and the inner wall matching keyways; the outer punching piece being provided with a plurality of first magnetic steel slots arranged along a circle and distributed close to an inner side of the outer punching piece and a plurality of second magnetic steel slots arranged along a circle and distributed away from the inner side of the outer punching piece, the outer wall of the outer punching piece being provided with a straight axis groove in the straight axis direction, and the outer wall of punching piece being provided with a cross axis groove in the cross axis direction.

2. The punching piece according to claim 1, wherein a number of straight shaft grooves is equal to a number of motor poles, a number of cross shaft grooves is equal to a number of motor poles, and the straight shaft grooves and the cross shaft grooves are arranged alternately.

3. The punching piece according to claim 1, wherein two first magnetic steel slots form a pair and constitute a “V” shape, and each pair of first magnetic steel slots are symmetrically distributed along a radial direction of the outer punching piece.

4. The punching piece according to claim 3, wherein two second magnetic steel slots form a pair and constitute a straight line shape, and each pair of second magnetic steel slots are symmetrically distributed along the radial direction of the outer punching piece.

5. The punching piece according to claim 4, wherein a gap between bottoms of the pair of first magnetic steel slots forms a first magnetic isolation bridge, a width of the first magnetic isolation bridge is not less than 1 mm and not greater than 2 mm, a gap between the pair of second magnetic steel slots forms a second magnetic isolation bridge, and a width of the second magnetic isolation bridge is not less than 0.7 mm and not greater than 1.2 mm.

6. The punching piece according to claim 5, wherein a straight shaft groove is a circular arc groove, and a radius of the straight shaft groove is not less than 1.1 times and not greater than 1.5 times the width of the first magnetic isolation bridge.

7. The punching piece according to claim 5, wherein the cross axis groove is a circular arc groove, and a radius of the cross axis groove is not less than 1.1 times and not greater than 1.5 times the width of the second magnetic isolation bridge.

8. The punching piece according to claim 1, wherein the outer punching piece is made of silicon steel and the inner punching piece is made of aluminum.

9. A rotor skewing structure of a permanent magnet motor for a vehicle, comprising a rotating shaft and a plurality of punching pieces of a permanent magnet motor rotor according to claim 1,
wherein the plurality of punching pieces are sleeved on the rotating shaft through the mounting hole, a rotating shaft matching key is interference fit with the rotating shaft matching keyway at a plurality of different angles on the inner punching piece to realize the multi-segment rotor skewing of the rotor with a V shape, a straight line shape, or a zigzag shape.

10. The rotor skewing structure according to claim 9, wherein a number of matching keyways of the rotating shaft is greater than or equal to a number of segments of multi-segment rotor skewings of the rotor.
